(19) United States
(12) Patent Application Publication
(10) Pub. No.: US 2006/0253622 A1
(43) Pub. Date: Nov. 9, 2006

(54) Method and device for congestion notification in packet networks indicating several different congestion causes

(76) Inventors: Henning Wiemann, Aachen (DE); Hannes Ekstrom, Stockholm (SE)

Correspondence Address: ERICSSON INC., 6300 LEGACY DRIVE, M/S EVR C11, PLANO, TX, 75024, US

(21) Appl. No.: 10/543,167

(22) PCT Filed: Jan. 28, 2003
(86) PCT No.: PCT/EP03/00850

§ 371 Date: Jan. 25, 2006

(51) Int. Cl. G06F 5/00

(52) U.S. Cl. 710/52; 370/231; 370/335; 370/413; 709/223

(57) ABSTRACT

A device for routing data units in a network, and a method of controlling a device for routing data units in a network, where the device 1 is capable of identifying one or more causes of congestion in the routing device and capable of setting congestion cause information in one or more forwarded data units.

### BACKGROUND OF THE INVENTION

Data unit based communication networks are well known in the art. An example of a data unit based communication network is the so-called Internet. In data unit based communication a sender divides data to be sent into a plurality of parts, places these data parts into data units and sends the data units into the network. A data unit has a structure defined by a communication protocol being used and contains addressing or routing information, such that the network can forward each data unit to the intended destination, i.e. the receiver to which the sender would like to transmit the data. This is well known in the art and does not need to be explained in more detail.

It is to be noted that within the context of various known communication protocols, such data units are sometimes referred to as packets, frames, segments, protocol data units (PDUs), etc. In the present application and claims, the term “data unit” is used generically to refer to any such data structure used for transport in a data unit oriented communication network.

The communication network will generally comprise a plurality of devices arranged for receiving data units and forwarding them in accordance with the addressing or routing information contained in each data unit. Such devices are referred to by various names, depending on the type of network and the communication protocols employed, such as routers, switches etc. The terms “device for routing” or “device for forwarding” as used in the present application and claims are employed generically to relate to any such device capable of receiving and forwarding data units in accordance with routing or addressing information contained in the data units.

Within such data based communication networks, the phenomenon of congestion is well known. Congestion means that a device for forwarding data units experiences an overload of data units and cannot forward as many data units as it receives. Devices for forwarding data units typically have a buffer for buffering data units to be forwarded. If such a buffer overflows, then this is one example of congestion occurring.

As already mentioned above, the Internet is an example of a data unit based communication network. The protocols governing the transport of data units in the Internet are the so-called transmission control protocol (TCP) and Internet Protocol (IP), which are together also referred to as TCP/IP. In a communication governed by TCP/IP, a sender sends data units to a receiver over the network, where the receiver sends back acknowledgement messages relating to the receipt of the sent data units. Based on these acknowledgement messages, the sender can adapt its control procedure. For example, if the sender performs flow control in accordance with a sliding-window based technique, then the size and movement of the window is adjusted in accordance with the received acknowledgement messages. As another example, if the sender is performing rate-based flow control, then the rate is adjusted on the basis of the received acknowledgement messages.

In its basic layout, a TCP/IP based network informs a sender of congestion by the indirect means of a routing device dropping data units. In other words, when a specific device for routing experiences buffer overload, then the excess data units are dropped, which means that they never arrive at the receiver. Consequently, by means of the corresponding acknowledgement messages (or lack of corresponding acknowledgement messages) the sender learns of the data unit loss. In accordance with TCP, a sender then enacts corresponding response procedures, e.g. a method known as slow-start. These response procedures are well known and need not be described in further detail.

As an improved mechanism for dealing with congestion in a TCP/IP-network, RfC 3168 proposes the concept of an Explicit Congestion Notification (ECN). The basic idea of ECN is to let a routing device in the network inform a sender of congestion by adding an explicit marking to data units being forwarded. It may be noted that such congestion notifications can be added to data units being transmitted in the direction from sender to receiver, and/or can be added to acknowledgement messages being transmitted from the receiver to the sender. If a marked data unit is being transferred in the forward direction (from sender to receiver) the congestion notification is mirrored in a corresponding acknowledgement message for that given data unit. When a data unit arrives at the sender with the congestion notification information set, the sender reacts according to predetermined procedures. In RfC 3168 an ECN field in the IP header is specified with two bits, which define four so-called ECN code points, i.e. 00, 01, 10 and 11. 10 and 01 indicate that the end-points (the sender and receiver) are ECN-capable. 00 indicates that ECN is not used. 11 is the information set by a routing device as a so-called CE (congestion experience) code point, to indicate congestion to the end nodes.

### OBJECT OF THE APPLICATION

The object of the present application is to provide an improved concept of dealing with congestion in data unit based communication. It is remarked that although the above description mentions TCP/IP as an example, the stated object applies to any data unit based communication system in which a type of congestion notification is used.

### SUMMARY OF THE INVENTION

The present object is solved by the subject-matter described in the independent claims. Advantageous embodiments are described in the dependent claims.

In accordance with one aspect of the invention, a device for routing data units and method of controlling such a device are provided, where the device for routing data units is capable of identifying one or more causes of congestion, such that in the event of congestion occurring, congestion cause information (information identifying the nature of the congestion) can be added to data units that are being forwarded.

In other words, while the prior art teaches to only indicate the presence or absence of congestion, the present invention proposes to distinguish between at least two different congestion causes, and to add corresponding congestion cause information to data units being forwarded, such that the sender and receiver of a communication are capable of in turn recognising not only the presence of congestion, but also one or more causes thereof, i.e. the nature of the congestion that is occurring. Consequently, according to a second aspect, the present invention also relates to a communication device for sending data units and a method for controlling such a sending communication device, which sending device is arranged to extract congestion cause information contained in messages received from the network, in order to adapt the operation of controlling the sending of data units in accordance with the congestion cause information.

It is noted that the congestion cause information can be provided in any suitable or desirable way. For example, it can be n bits (n>2), in order to distinguish between the presence or absence of n congestion causes. It may be noted that the concept of an explicit congestion notification and a congestion cause information can be combined in such a way that the congestion cause information itself also serves as a congestion notification information, or the two can be separate. In the latter case, one or more designated bits in a data unit serve as congestion notification information, while other designated bits serve as congestion cause information, whereas in the former case the same set of designated bits serves both as congestion notification information and congestion cause information.

Using the concepts of the present invention, the response to congestion can be specifically tailored to the cause of congestion, which is a great improvement over the prior art. Expressed differently, while the prior art only taught to inform the sender and receiver in a communication of the presence of congestion, the present invention also informs the sender and receiver of the cause of congestion, such that the sender can take specific measures designed to specifically cope with the one or more identified causes. As an example, let it be assumed that a routing device is arranged in such a way that it can distinguish between two different causes of congestion: processing limitation and bandwidth limitation. Processing limitation describes a situation in which the routing device has problems in handling the number of packets arriving per unit of time. In other words, data units accumulate in a buffer because the routing device does not have sufficient capacity for processing the number of data units arriving per unit of time. Bandwidth limitation refers to the situation in which the output link or links have problems handling the amount of data to be forwarded per unit of time. In other words, the bandwidth on the output link(s) is not sufficient for handling the amount of data to be forwarded per unit of time.

In the prior art systems, the routing device would only be able to set a congestion encountered (CE) bit, which indicates to the communication end points that congestion is occurring. However, there would be no information on the causes. In contrast thereto, the concepts of the present invention allow a routing device to add congestion cause information, e.g. an information that indicates whether a processing limitation is being encountered, a bandwidth limitation or a processing limitation and a bandwidth limitation. On the basis of such information, a data unit sender can react much more appropriately. This shall be explained on the basis of the following example. If one considers a rate-based application on the sending side, such as e.g. voice-over-IP (VoIP), then it is useful to react differently to processing limitation than to bandwidth limitation. Namely, in reaction to processing limitation, it is suitable to reduce the number of data units being output by the sender per unit of time while increasing the packet size, whereas a suitable reaction to bandwidth limitation consists in reducing the total amount of data being output per unit of time i.e. the rate, but retaining the number of data units being output per unit of time. If both bandwidth and processing limitation are occurring, then the sender can react by simultaneously reducing the number of data units being sent per unit of time and reducing the total amount of data being sent per unit of time.

### BRIEF DESCRIPTION OF THE DRAWINGS

In the following, embodiments of the present invention will be described with reference to the figures, in which:

FIG. 1 shows an embodiment of a device for routing data units according to the present invention;

FIG. 2 shows a flowchart of a method according to the present invention;

FIG. 3 shows a schematic presentation of a data unit sender and data unit receiver, as well a network comprising routing devices;

FIG. 4 shows a schematic representation of a data unit according to the invention; and

FIG. 5 shows a flowchart of a method for controlling a sending communication device according to an embodiment of the present invention.

### DETAILED DESCRIPTION OF THE EMBODIMENTS

Although the following description of preferred embodiments of the present invention will sometimes make reference to TCP/IP as an example, it should be noted that the present invention is by no means restricted to TCP/IP, as it can be applied in the context of any data unit based communication in which congestion notification is used. It should therefore be noted that the term “congestion notification” as used in the present specification and the claims is used generically and not to be seen as restricted to ECN as specified in RfC 3168.

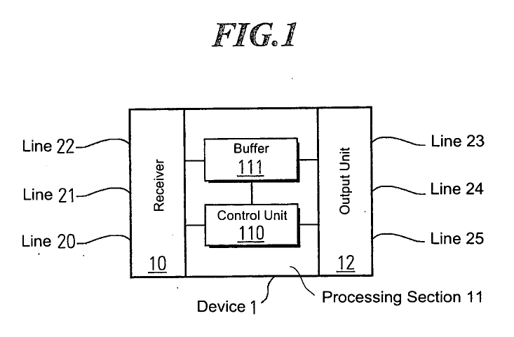

FIG. 1 shows a schematic representation of a device for routing data units in a network according to an embodiment of the invention. The routing device is referred to as 1. It is connected to lines 20, 21, 22, 23, 24, 25, which represent connections to a network of which the device 1 for routing is a part. The lines 20-25 are only an example, as a routing device may have an arbitrary number of connections to its network. These connections may be physical and/or logical in nature. Reference numeral 10 refers to a receiver for receiving data units from the network and reference numeral 12 refers to an output unit for outputting data units to the network. The device 1 for routing data units furthermore comprises a processing section 11 comprising a buffer 111 and a control unit 110. The control unit 110 is arranged to control the operation of the device 1. For this purpose, the control unit 110 may comprise control elements consisting of hardware, software or any suitable combination of hardware and software.

The buffer 111 is arranged to buffer data units received by the receiver 10. The output unit outputs buffered data units to the network on the basis of routing information contained in the data unit that are to be forwarded.

Beyond the controlling of receiving data units in receiver 10, buffering data units in buffer 111 and outputting data units via output units 12, the controller 110 furthermore comprises a congestion monitor (e.g. a suitable computer program or software element executed by controller 110) for monitoring whether the device 1 fulfils a predetermined congestion condition. The controller 110 furthermore has a congestion notification unit (e.g. an appropriate software element executed in the controller 110) for setting congestion notification information in one or more data units output by the output unit 12, if the congestion monitor determines that the congestion condition is fulfilled.

The specific congestion condition monitored by the congestion monitor can be selected as is suitable or desirable. For example, it can be determined that the congestion condition is fulfilled if the degree of utilization of at least one of one or more resources of device 1 fulfils a predetermined condition. The fulfilment can e.g. be the exceeding of a predetermined threshold. Examples of resources that can be monitored in order to determine whether a congestion condition is given are a buffering capacity and a data unit processing capacity. For example, it can be determined that a congestion condition is given if the amount of data in buffer 111 exceeds a predetermined threshold. Is should be noted that the predetermined threshold in this case can be adjusted in any way that is indicative of congestion, i.e. can be smaller than the overflow limit of buffer 111. In fact, it is desirable to choose the threshold lower than the overflow limit, because then a congestion notification is given prior to buffer overflow, such that buffer overflow may in fact be avoided all together.

In addition to or in place of monitoring the degree of buffer utilization, another resource that can be monitored is the amount of processing capacity used by controlling unit 110 for handling data units in the transfer between the receiver and the output unit. For example, if the controller 110 is a processor, then the amount of processor time allocated to the handling of data units can be monitored in order to observe the degree of utilization of the processing capacity.

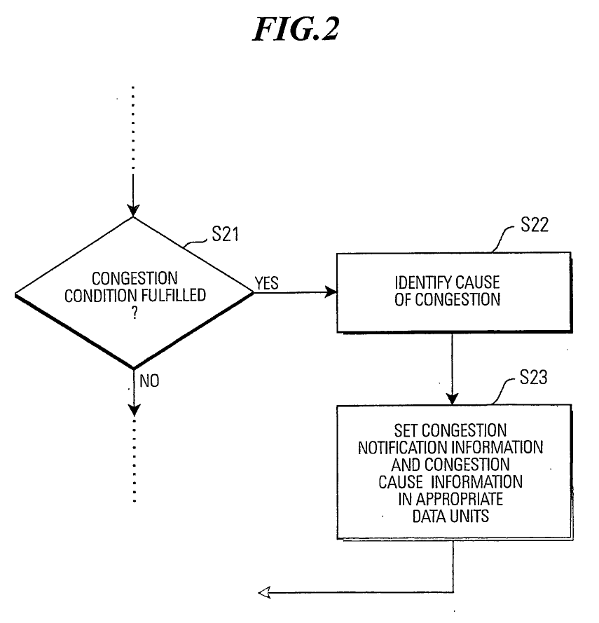

In accordance with the embodiment shown in FIG. 1, the device 1 for routing is arranged to implement a procedure shown in FIG. 2. In other words, the control unit 110 comprises a congestion cause identifying unit (e.g. in the form of a software program executed in control unit 110) capable of distinguishing between at least two different congestion causes, for identifying one or more causes of the congestion monitor detecting that the congestion condition is fulfilled. In FIG. 2, this is shown as a step S21 within the overall flow of control operations (said overall flow being indicated by the vertical dotted lines on the left-hand side of FIG. 2), which determines whether the predetermined congestion is fulfilled. If not, then the regular control routine, which is not the focus of the present application, is continued. However, if it is determined in step S21 that the congestion condition is fulfilled, then the procedure branches to step S22, in which the congestion cause identifying unit identifies the cause of congestion.

Furthermore, the congestion notification unit is arranged to implement step S23 shown in FIG. 2, namely, for setting congestion cause information based on the one or more causes identified by the congestion cause identifying unit in step S22. This information is set in one or more data units in which congestion notification information is set.

It is noted that the device for routing 1 can comprise a plurality of congestion notification units, e.g. one for each congestion cause that can be set in a data unit. For example, there can be one congestion notification unit that sets a bit indicating processing limitation and one congestion notification unit that sets a bit indicating bandwidth limitation.

The congestion notification and congestion cause information can be set in any desired or suitable data units. For example, the information can be set only in such data units that comprise a specified source information (indicative of the sender) or a specified destination information (indicative of the receiver). Preferably, the congestion cause information will be set in all data units output from the output unit 12 while the congestion condition is present.

The congestion cause identifying unit operated to implement step S22 is capable of distinguishing between at least two different congestion causes. The congestion cause information set in step S23 provides an indication whether none, one or several of the at least two different congestion causes are present.

The congestion cause identifying unit can operate in any suitable or desirable way. For example, the mechanism for distinguishing between different causes of congestion and identifying a cause can be accomplished by observing the degree of utilization of two or more resources of the routing device 1, and identifying one or more causes on the basis of the observed degrees of utilization. In keeping with the above-described examples, the observed resources can e.g. be a buffering capacity and a data processing capacity. It should be noted that several buffer capacities and several data unit processing capacities can be observed. For example, the device 1 for routing can be arranged to observe the buffering capacity associated with the receiver for buffering data units upon receipt by the receiver, and can be arranged to monitor the buffering capacity associated with the output unit for buffering data units to be output. These buffering capacities can both be provided by a single physical buffer (e.g. the buffer 111 shown in FIG. 1), but can also be provided by a plurality of physical buffers, e.g. one buffer provided in receiver 10 and several output buffers provided in output unit 12. For example, each output line 23-25 can have its own respective output buffer. Alternatively, these buffering capacities can be represented by individual logical queues that are logically managed by buffer 111, e.g. an input queue associated with receiver 10 and a plurality of output queues associated with output 12.

The plurality of processing capacities that can be monitored can e.g. be a processing capacity for controlling a transfer of data units from the receiver to the output unit or a processing capacity for controlling the output of data units from the output unit 12. This processing capacity can e.g. be provided by the control unit 110, which is generally a processor that executes predetermined software in order to provide the desired control function. The utilization of processing capacity can then e.g. be monitored by monitoring the amount of processor capacity assigned to the respective task. In other words, the processing capacity for controlling a transfer of data units from the receiver 10 to the output unit 12 can be monitored by observing the amount of processor time used for controlling this transfer, and the processing capacity for controlling the output data units from the output unit 12 can be monitored by observing the amount of processor time used for controlling the output of data units from the output unit 12 to output lines 23-25.

As already mentioned, the congestion cause identifying unit may distinguish between different causes of congestion by observing the degree of utilization of two or more resources of device 1. Preferably, this is done by grouping the resources into one or more first resources and one or more second resources, where the congestion cause identifying unit is arranged to identify a first cause on the basis of the degree of utilization of the first resources, and to identify a second cause on the basis of the degree of utilization of the second resources. For example, a first resource can be a buffering capacity associated with receiver 10, where the degree of utilization of this input buffer capacity (e.g. the amount of data in the input buffer) is observed, and a processing limitation As determined as a first cause if the amount of data in the input buffer exceeds a predetermined threshold. As a second resource, one or more output buffer capacities associated with the buffering of data units to be output to respective output lines 23-25 can be monitored, and a bandwidth limitation can be identified as a second cause of congestion if one or more of these output buffer capacities is used to such an extent that predetermined threshold values are exceeded.

Regarding the example of FIG. 1, it should be noted that although element 10 was described as a receiver or receiving entity and element 12 as an output unit or outputting entity, this was for the purpose of clearer description, and in general, a routing device will be arranged in such a way that the entity 10 will also be capable of outputting data units to be forwarded, just as entity 12 will be capable of receiving data units from the network. Furthermore, the buffer 111 and control unit 110 will also be arranged to control the transfer from data units received from a line connected to entity 10 to another, different line equally connected to entity 10, or to control the transfer of data units received at entity 12 from one line to another line connected to entity 12. As such, a routing device can also be constructed as having a single receiving/outputting unit to which a plurality of network connections are connected. A buffer and control unit will then be connected to this input/output unit, in order to control the transfer and forwarding of data units from one network connection (acting as input link) to another network connection (acting as an output link). In such an embodiment, the receiver 10 and the output unit 12 are a single physical entity.

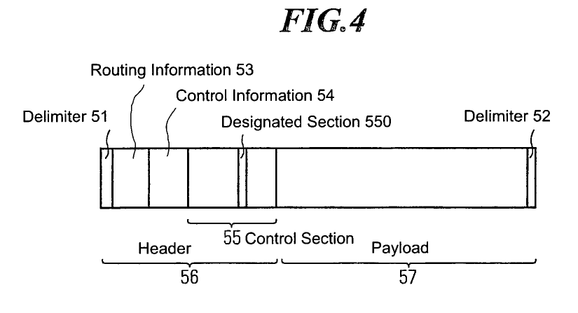

The setting of congestion cause information in data units can be accomplished in any suitable or desirable way. For example, a predetermined set of bits in a specified part (e.g. the header) of data units can be reserved for carrying the congestion cause information. This is shown in the schematic example of FIG. 4, which represents a data unit. The data unit comprises delimiters 51 and 52, which mark the beginning and end, respectively, of the data unit. Section 56 represents a header, and section 57 a payload. The header 56 can e.g. be divided into a variety of sections comprising specified information, such as in section 53 identifying the type of the data unit, section 54 containing routing information for routing the data unit, and section 55 containing a variety of control information, such as error correction information (e.g. cyclic redundancy check data). In the example of FIG. 4, the control section 55 of the data unit also has a designated section 550, in which the congestion control information is set. In a simple case, the congestion cause information can consist of two bits. This provides four combinations, where a first combination (e.g. 00) indicates no congestion, a second combination (e.g. 10) indicates the presence of a first congestion cause, a third combination (e.g. 01) indicated the presence of a second congestion cause, and a fourth combination (e.g. 11) indicates the presence of both the first and second congestion cause. Naturally, the congestion cause information can comprise an arbitrary number n of bits in order to provide 2ⁿ combinations of congestion causes.

It should be noted that the data unit shown schematically in FIG. 4 is only an example, and other data structures are possible, e.g. using a trailer instead of or in addition to a header.

As already mentioned earlier, the congestion cause information can structurally be identical with the congestion notification information. This can be seen in the above example, where 00 represents no congestion, and any other combinations represents congestions. Further, it is equally well possible to implement the congestion cause information as an additional set of information to a congestion notification information. For example, when using TCP/IP one can retain the ECN mechanism as defined in RfC 3168, and simply define an additional set of bits that conveys the additional congestion cause information. The advantage of keeping congestion notification information and congestion cause information separate is that a backwards compatibility with such systems that are capable of processing congestion notification information, but not capable of processing congestion cause information, is provided.

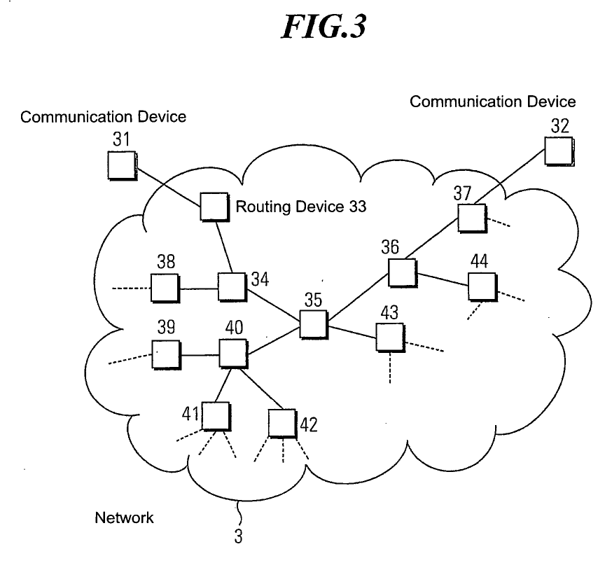

Now a further aspect of the present invention will be described, namely the exploitation of the congestion cause information by a communication device that sends data units into a network. This is schematically shown in FIG. 3. Reference numeral 3 refers to a network that contains routing or forwarding devices 33-44. The various routing devices 33-44 are interconnected, and furthermore connected with other routing devices not shown in FIG. 3, which is indicated by dotted lines. FIG. 3 furthermore shows a first communication device 31, which is connected to network 3 and acts as a sending communication device, and a second communication device 32, which is also connected to network 3 and acts as a receiving communication device. More specifically, the sending communication device 31 sends data units into the network 3 via a connection with routing device 33. The connection between communication device 31 and routing device 33 can be established in any desired or suitable way, e.g. can be a fixed wire line or can be a wireless connection. The data units sent by the communication device 31 in the network 3 comprise routing or addressing information, such that the network 3 is capable of forwarding the data units to the desired destination 32. This basic concept is well known in the art and therefore does not need to be described in more detail.

In accordance with the present application, one or more of the routing devices 33-44 is arranged as described in connection with FIG. 1, i.e. the routing devices operating in accordance with the invention are not only capable of monitoring whether congestion has occurred, but are also capable of identifying a cause of congestion and setting appropriate information in appropriate corresponding data units. Preferably, the congestion cause information will be set in all data units output from the output unit 12 (see FIG. 1) while the congestion condition is present.

The forwarded data units are received by receiving communication device 32, where the receiving communication device 32 is arranged to send acknowledgement message into the network 3. The acknowledgement messages contain routing or addressing information that directs the acknowledgement messages to sending communication device 31. The acknowledgement messages contain receipt information regarding the receipt of data units, and possibly contain congestion notification information and congestion cause information set by one or more routing devices in forwarded data units. In other words, the receiving communication device 32 is arranged to mirror congestion notification information and/or congestion cause information contained in received data units. The basic mechanism of sending acknowledgement messages in response to receiving data units from a sending communication device is well known as ARQ (Automatic Repeat reQuest) in the art, such that a further description is not necessary.

The acknowledgement messages are then forwarded by network 3 to the sending communication device 31. It should be noted that the routing devices operating in accordance with the concepts of the present invention are not only capable of setting congestion notification and congestion cause information in data units being sent in the forward direction (from sending communication device 31 to receiving communication device 32), but also capable of setting congestion notification information and congestion cause information in acknowledgement messages being sent in reverse direction (i.e. from the receiving communication device 32 to the sending communication device 31). It may be noted that the acknowledgment messages are also data units, e.g. like shown in FIG. 4.

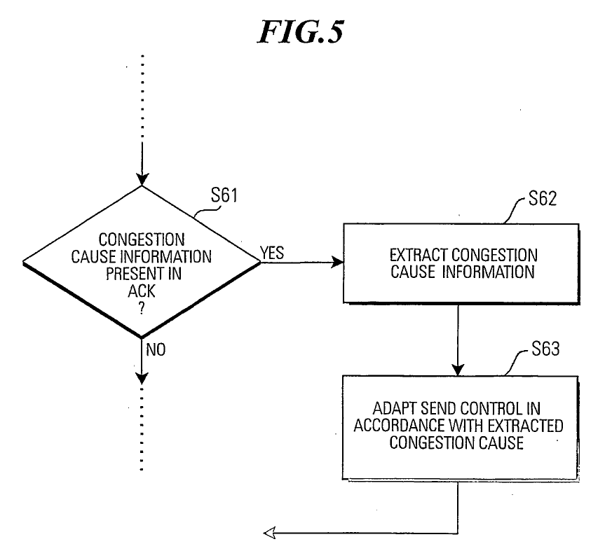

A sending communication device 31 according to the present invention is arranged such that it may execute the method schematically shown by the flowchart of FIG. 5. Namely, in a step S61 which occurs in the overall control procedure of communication device 31, it is determined whether congestion cause information is present in a received acknowledgement message. If not, then the regular control continues. If congestion cause information is present in a received acknowledgement message, the procedure branches to step S62, in which the congestion cause information is extracted, and in subsequent step S63 the control procedure is adapted in accordance with the extracted congestion cause. As already specified earlier, the congestion cause information can be designed in such a way that it can indicate the presence or absence of n different causes of congestion, where each acknowledgement message can thereby contain one of 2ⁿ different combinations of congestion causes. The communication device 31 operating in accordance with the present invention can then e.g. be arranged to simply identify a congestion cause combination (e.g. a specific bit combination) in a specified field (namely the congestion cause field) of an acknowledgement message, and to invoke a response procedure corresponding to the identified congestion cause combination. As an example, the communication device 31 can keep a record or table of possible congestion cause combinations (e.g. respective bit patterns) where each congestion cause information is linked to an associated response procedure. It is possible that each different congestion causes combination is linked to a different response procedure or that several different congestion combinations are linked to the same response procedure. This will generally depend on the specific system and can be chosen as is suitable or desirable.

According to a preferred embodiment, the communication device 31 is arranged to extract first and second congestion cause information, where the first congestion cause information is associated with congestion due to the incapacity to handle the number of data units being transported over the network (i.e. processing limitation) and the second congestion cause information is associated with congestion due to the incapacity to handle the amount of data being transported (i.e. bandwidth limitation). Then, the communication device 31 is preferably arranged such that it responds to the extraction of the first congestion cause information by reducing the number of data units output to the network per unit of time, and to respond to the extraction of the second congestion cause information by reducing the amount of data output to the network per unit of time.

Regarding the setting of congestion cause information in the form of individual bits in a predetermined number n of bits, it should be noted that when a plurality of routing devices along a connection are capable of setting one or more bits that correspond to respective congestion causes, then consecutive routing devices can set different bits depending on their individual congestion state. As an example, if the congestion cause information is such that two causes are distinguished (i.e. two bits are used), it is possible that a first routing device will set the first bit to 1 (thereby e.g. indicating a processing limitation) and a second routing device (e.g. 36 in FIG. 3) sets the second bit to 1 (thereby indicating a bandwidth limitation). In this way, after mirroring the congestion cause information in an acknowledgement message sent by receiving communication device 32, the sending communication device 31 is informed that both the first congestion cause (e.g. processing limitation) and the second congestion cause (e.g. bandwidth limitation) are present in the network 3.

The above-described concept associated with modifying a sending communication device is preferably applied to rate-based sending applications. As an example, one may consider a Voice-over-IP (VoIP) application using a codec that outputs a speech frame within a predetermined time period. For example, the AMR (adaptive multi rate) codec outputs one speech frame every 20 ms. The codec is capable of switching its encoding rate on a per frame basis between a plurality of different encoding rates. For example, the AMR codec is capable of switching between 8 different encoding rates ranging from 4.75 to 12.2 kbps. The speech frames output by the codec are embedded into data units that can be sent over the network. For example, the speech frames could be consecutively embedded into a Real-time Transport Protocol (RTP) data unit, a Datagram Congestion Control Protocol (DCCP) data unit and then an Internet protocol (IP) data unit.

According to a preferred example of the invention, the congestion cause information is coded as two bits, where a first combination (e.g. 00) indicates no congestion, a second combination (e.g. 10) indicates the presence of processing limitation, a third combination (e.g. 01) indicates the presence of bandwidth limitation and a fourth combination (e.g. 11) indicates the presence of both processing and bandwidth limitation.

Upon reception of feedback (i.e. an acknowledgement message) from the network, the VoIP application could use an appropriate decision table, where 00 is linked to no response (this corresponds to the outcome “no” in step S61 of the example shown in FIG. 5), and where 10 is linked to a response option 1, 01 is linked to a response option 2 and 11 is linked to a response option 3.

Response option 1 can then consist in reducing the number of data units (e.g. IP packets) output by the application, by increasing the number of speech frames per data unit. This is an appropriate reaction to processing limitation, because the network receives a reduced number of data units to process per unit of time. From the point of view of the VoIP application, this leads to an increased delay.

Response option 2 can consist in leaving the number of speech frames per data unit constant and instead reducing the coding-rate. This results in a constant number of data units, however, each individual data unit is smaller. This is an appropriate reaction to bandwidth limitation, since the amount of data (i.e. the number of bytes) arriving in the network decreases. From an application point of view, the penalty to be paid is a decreased quality.

Response option 3 can consist in implementing both options 1 and 2, i.e. reducing the encoding rate and increasing the number of speech frames per data unit. From the view point of the application, this response leads to decreased quality and increased delay.

In comparison with the system of the prior art, the benefit of the present application is immediately recognisable from the above example. Namely, while the prior art only indicates the presence or absence of congestion, the present invention allows to distinguish the causes of congestion. This means that in the prior art, the above situation with respect to a VoIP application forces to implement response option 3 in reaction to a congestion notification, because it can not be determined what the causes are. As one can not determine the cause, one has to provide a reaction that is capable of alleviating all possible causes, e.g. processing limitation and bandwidth limitation. This then has the consequence that in the event of congestion, one always has a decrease in quality and increase in delay.

In contrast thereto, the present invention is such that the cause of congestion can be identified, such that the correct reaction on the part of the sending communication device can be enacted, which in turn means that only the necessary performance degradation has to be tolerated. In other words, in the event of processing limitation, one only has to tolerate increased delay, but not decreased quality, and in the event of bandwidth limitation, one only has to tolerate decreased quality, but not increased delay.

Although the above example is related to VoIP, it is to be noted that the same positive effects of the present invention can be achieved in any application using congestion feedback, such as streaming, mobile gaming and any application using TFRC (TCP Friendly Rate Control) and/or TFRC-PS (TCP Friendly Rate Control Packet Size) for congestion control. Naturally, the individual response options will depend on the specific application and the individual requirements associated therewith.

Embodiments of the present invention can be provided in the form of hardware, software or any suitable combination of hardware and software. The present invention can also be embodied in the form of a data carrier storing a computer program that is capable of executing a method according to the invention.

Although the present invention has been described by way of examples, these only serve to provide a comprehensive understanding and are not intended to be limiting. Much rather, the scope of the present invention is determined by the appended claims. Furthermore, reference numerals in the claims are not limiting, but only serve to make the claims easier to read.

1. A device for routing data units in a network, comprising
a receiver for receiving data units from said network,
a buffer for buffering data units received by said receiver,
an output unit for outputting buffered data units to said network on the basis of routing information contained in said data units,
a control unit comprising
means for monitoring whether said device fulfils a predetermined congestion condition,
means for setting congestion notification information in one or more data units output by said output unit, if said means for monitoring determines that said congestion condition is fulfilled,
and means for distinguishing between at least two different congestion causes, for identifying one or more causes of congestion conditions detected fulfilled by said means for monitoring, and
said means for setting congestion notification information being arranged for setting congestion cause information based on the one or more causes identified by said means for distinguishing and identifying congestion causes in said one or more data units in which congestion notification information is set.

2. The device according to claim 1, wherein said means for monitoring is arranged to monitor the degree of utilization of one or more resources of said device, and to determine that the congestion condition is fulfilled if the degree of utilization of at least one of said one or more resources fulfils a predetermined condition.

3. The device according to claim 2, wherein said predetermined condition is the exceeding of a predetermined threshold.

4. The device according to claim 1, wherein said means for distinguishing and identifying congestion causes is arranged to observe the degree of utilization of two or more resources of said device, and to identify said one or more causes on the basis of the observed degrees of utilization.

5. The device according to claim 2, wherein said resources comprise a buffering capacity and a data unit processing capacity.

6. The device according to claim 4, wherein said resources are grouped into one or more first resources and one or more second resources, and said means for distinguishing and identifying congestion causes is arranged to identify a first cause on the basis of the degree of utilization of said first resources and a second cause on the basis of the degree of utilization of said second resources.

7. The device according to claim 6, wherein said first resources comprise a buffering capacity associated with said receiver for buffering data units upon receipt by said receiver, or a processing capacity for controlling a transfer of data units from said receiver to said output unit, and said second resources comprise a buffering capacity associated with said output unit for buffering data units to be output, or a processing capacity for controlling the output of data units from said output unit.

8. A method of controlling a device for routing data units in a network, comprising
receiving data units from said network,
buffering data units received by said receiver,
outputting buffered data units to said network on the basis of routing information contained in said data units,
monitoring whether a predetermined congestion condition is fulfilled,
setting congestion notification information in one or more output data units if said congestion condition is fulfilled,
identifying one or more causes of said congestion condition being fulfilled, and
setting congestion cause information based on the one or more identified causes in said one or more data units in which congestion notification information is set.

9. The method according to claim 8, wherein the degree of utilization of one or more resources of said device is monitored, and it is determined that the congestion condition is fulfilled if the degree of utilization of at least one of said one or more resources fulfils a predetermined condition.

10. The method according to claim 9, wherein said predetermined condition is the exceeding of a predetermined threshold.

11. The method according to claim 8, wherein the degree of utilization of two or more resources of said device is observed, and said one or more causes are identified on the basis of the observed degrees of utilization.

12. The method according to claim 9, wherein said resources comprise a buffering capacity and a data unit processing capacity.

13. The method according to claim 11, wherein said resources are grouped into one or more first resources and one or more second resources, and a first cause is identified on the basis of the degree of utilization of said first resources and a second cause is identified on the basis of the degree of utilization of said second resources.

14. The method according to claim 13 wherein said first resources comprise a buffering capacity associated with said receiver for buffering data units upon receipt by said receiver or a processing capacity for controlling a transfer of data units from said receiver to said output unit, and said second resources comprise a buffering capacity associated with said output unit for buffering data units to be output or a processing capacity for controlling the output of data units from said output unit.

15-16. (canceled)

17. A communication device for sending data units to a receiving communication device over a network, said communication device for sending being arranged to receive from said receiving data communication device acknowledgment messages that contain receipt information regarding the receipt of sent data units and congestion notification information regarding congestion in the network, said communication device for sending being arranged to respond to said acknowledgment messages by adapting an operation of controlling the sending of data units in accordance with the information contained in said acknowledgment messages, wherein
said communication device for sending is arranged to extract congestion cause information contained in said acknowledgment messages, and to adapt the operation of controlling the sending of data units in accordance with said congestion cause information.

18. The device according to claim 17, wherein the congestion cause information is designed such that the congestion cause information in an acknowledgment message can indicate the presence or absence of n different causes of congestion, such that each acknowledgment message containing congestion cause information contains one of 2ⁿ different combinations of congestion causes, n being an integer, and said communication device for sending is arranged to identify the congestion cause combination contained in an acknowledgment message and to invoke a response procedure corresponding to the identified congestion cause combination.

19. The device according to claim 17, wherein said communication device for sending is arranged to extract at least a first and a second congestion cause information, said first congestion cause information being associated with congestion due to the incapacity to handle the number of data units being transported, and said second congestion cause information being associated with congestion due to the incapacity to handle the amount of data being transported, and said communication device for sending is arranged to respond to the extraction of said first congestion cause information by reducing the number of data units output per unit of time, and to respond to the extraction of said second congestion cause information by reducing the amount of data output per unit of time.

20. A method for controlling a sending communication device that is sending data units to a receiving communication device over a network, comprising:
receiving from said receiving communication device acknowledgment messages that contain receipt information regarding the receipt of sent data units and congestion notification information regarding congestion in the network,
responding to said acknowledgment messages by adapting an operation of controlling the sending of data units in accordance with the information contained in said acknowledgment messages,
extracting congestion cause information contained in said acknowledgment messages at said sending communication device, and
adapting the operation of controlling the sending of data units in accordance with said extracted congestion cause information.

21. The method according to claim 20, wherein the congestion cause information is designed such that the congestion cause information in an acknowledgment message can indicate the presence or absence of n different causes of congestion, such that each acknowledgment message containing congestion cause information contains one of 2ⁿ different combinations of congestion causes, n being an integer, and said method further comprising:
identifying the congestion cause combination contained in an acknowledgment message and
invoking a response procedure corresponding to the identified congestion cause combination.

22. The method according to claim 20, wherein said sending communication device is arranged to extract at least a first and a second congestion cause information, said first congestion cause information being associated with congestion due to the incapacity to handle the number of data units being transported, and said second congestion cause information being associated with congestion due to the incapacity to handle the amount of data being transported, and said method further comprising:
responding to the extraction of said first congestion cause information by reducing the number of data units output per unit of time, and
responding to the extraction of said second congestion cause information by reducing the amount of data output per unit of time.

23-24. (canceled)

25. A method of sending data units over a network, comprising:
sending data units into said network out of a sending communication device connected to said network,
forwarding said data units in one or more routing devices of said network to a receiving communication device connected to said network, each routing device buffering data units received from said network, outputting buffered data units to said network on the basis of routing information contained in said data units, monitoring whether a predetermined congestion condition is fulfilled, setting congestion notification information in one or more output data units if said congestion condition is fulfilled, identifying one or more causes of said congestion condition being fulfilled, and setting congestion cause information based on the one or more identified causes in said one or more data units in which congestion notification information is set,
receiving said forwarded data units at said receiving communication device, said receiving communication device sending acknowledgment messages into said network, said acknowledgment messages containing receipt information regarding the receipt of said forwarded data units as well as congestion notification information and congestion cause information set by said one or more routers in said forwarded data units,
forwarding said acknowledgment messages through said network to said sending communication device,
receiving said acknowledgment messages at said sending communication device and responding to said acknowledgment messages by adapting an operation of controlling the sending of data units in accordance with the information contained in said acknowledgment messages, extracting said congestion cause information contained in said acknowledgment messages at said sending communication device, and adapting the operation of controlling the sending of data units in accordance with said extracted congestion cause information.
